(19) United States
(12) Patent Application Publication
(10) Pub. No.: US 2017/0337003 A1
(43) Pub. Date: Nov. 23, 2017

(54) System and Method for Concurrent Indexing and Searching of Data in Working Memory

(71) Applicant: DataStax, Santa Clara, CA (US)

(72) Inventors: Jason John Rutherglen, Las Vegas, NV (US); Maciej Zasada, Warsaw (PL)

(21) Appl. No.: 15/158,956

(22) Filed: May 19, 2016

(51) Int. Cl. G06F 3/06

(52) U.S. Cl. CPC G06F 3/0631; G06F 3/0683; G06F 3/0659; G06F 3/0604; G06F 3/0611; G06F 3/064

(57) ABSTRACT

Systems and methods are described herein for concurrently storing and searching an index in the working memory of a computing system. The present approach has multiple levels of storage block pools, each level made up of one or more storage block subdivided into slices, the slices being larger in size at higher pool levels, where additional storage pool blocks are allocated at a given level when there are no more slices available at that level. Further, the index is encoded as straight integer values, rather than using delta encoding or variable integer compression. The stored values can therefore be directly searchable without first having to flush the index from working memory into long term storage.

### FIELD OF THE INVENTION

The present invention relates generally to indexing and searching data, and more particularly to concurrently performing such operations in working memory of a computing system.

### BACKGROUND OF THE INVENTION

In order to more rapidly and efficiently search text-based digital data files, such data files are not simply stored as a group of separate data files, as may occur with physical files stored in folders in file cabinet, to individually be searched. Instead, the data files are indexed to create an index file, which index file is then used for the search operation. Using such an index file, once the search function has identified particular data files of interest, those particular data files can then be retrieved as desired.

This approach is used by Apache Lucene, which is an open-source text search-engine library available from the Apache Software Foundation (see http://lucene.apache.org). Lucene can be used to index any data that is in a textual format. Text from documents of various types, e.g., Portable Document Format (PDF), Hypertext Markup Language (HTML), Microsoft Word, etc., can all be indexed as long as their textual information can be extracted. Indexing is a process of converting text data into a format that facilitates rapid searching. A simple analogy is an index found at the end of a book which points to the location of topics of interest that appear in the book.

In the indexing operation, Lucene stores the input data in a data structure known as an inverted index, which is stored as a set of index files. Lucene uses a combination of delta encoding and variable integer (Vint) compression. In particular, data file document identifiers (Doc IDs) are converted into document gaps, or differences between consecutive Doc IDs, a form of delta encoding. These gaps are then compressed using integer coding techniques, such as Vint. The following table is an encoding example for a single term found in five separate data files:

| | |
|---|---|
| posting list (Doc IDs) | 1, 50, 51, 70, 200 |
| delta encoded posting list | 1, 49, 1, 19, 130 |
| size in bytes after VInt compression | 1B, 1B, 1B, 1B, 2B |

As can be seen by the above example, instead of using 20 bytes (4 bytes per integer for each of the 5 Doc IDs), Lucene uses only 6 bytes to encode that single term thereby reducing the amount of memory needed to store that term in the index.

As known in the art, an inverted index can then be used to perform fast keyword look-ups to find the data file documents that match a given query. Before the text data is added to the index, it is processed by an analyzer, using an analysis process, to convert the text data into a fundamental unit of searching, known as a term. Searching, then, is the process of looking for words in the index and finding the data file documents that contain those words.

In the process of creating the index, known as a postings list, Lucene stores the postings list in a Random Access Memory (RAM) buffer, which is an in-memory (i.e., working memory of a computing system) data structure. Then, either periodically (e.g., once per second) or when the RAM buffer becomes full, the postings list is flushed from working memory (i.e., the RAM buffer) to long term storage (i.e., disk, or some form of non-volatile memory).

Lucene's indexing process and storage into the RAM buffer involves a number of tradeoffs that provide some benefits yet also create some limitations, as will now be explained. Allocation of space for postings lists in the RAM buffer needs to be dynamic because it is only bounded by the size of the data file document collection itself. This makes it difficult to choose the correct amount of RAM buffer memory to allocate. Selecting a value that is too large leads to inefficient memory utilization due to the remaining unused portion. On the other hand, selecting a value that is too small leads to waste both in time spent allocating additional memory and also in memory space because non-contiguous storage requires pointers to chain them together (in the limit, allocating one posting at a time is akin to a linked list). Further, during postings traversal, blocks that are too small may also result in suboptimal memory access patterns (e.g., due to cache misses, lack of memory prefetching, etc.).

Lucene maintains a single, unbounded pool of fixed-sized 32 kilobyte (kB) blocks for holding postings. Initially, the pool size is 10, which means Lucene allocates 10 blocks upfront. Lucene then allocates what are known as slices for storage of individual postings belonging to a term, with increasing slice sizes as greater portions of a block are needed to store an individual term. In particular, once Lucene fills a slice, it allocates another slice, copies the last four bytes of the filled slice into the first four bytes of the new slice, and writes the RAM buffer address of the new slice into the last four bytes of the filled slice thereby linking the slices together. Finally, when all 10 blocks in the pool are full, Lucene allocates a new larger, single pool of a greater number of blocks, and copies the data from the full, smaller pool to the new, larger pool.

The following is a table listing Lucene's slice sizes for each allocated slice level, the number of bytes allocated per slice at each slice level, the number of bytes used to store posting list data if an additional slice level is allocated, and the number of bytes used to store the pointer to the allocated additional slice at each level:

| | Number of | Bytes containing | Bytes used for |
|---|---|---|---|
| Level | bytes | posting list data | next address |
| 0 | 5 | 1 | 4 |
| 1 | 14 | 10 | 4 |
| 2 | 20 | 16 | 4 |
| 3 | 30 | 26 | 4 |
| 4 | 40 | 36 | 4 |
| 5 | 40 | 36 | 4 |
| 6 | 80 | 76 | 4 |
| 7 | 80 | 76 | 4 |
| 8 | 120 | 116 | 4 |
| 9+ | 200 | 196 | 4 |

Referring now to FIG. 1, an example Lucene initial pool 100 in a RAM buffer is shown. Being an initial or first pool, pool 100 is, as explained above, a fixed-size of 32 kB blocks allocated to hold postings. As shown, a first term has been stored in a first slice, slice 103, which is a Lucene level zero slice of 5 bytes. As also shown, a portion of a second term has been stored in a second slice, slice 105, which is also a Lucene level zero slice of 5 bytes. However, because the second term is larger than a Lucene level zero slice of 5 bytes, a Lucene level one slice of 14 bytes, shown in the figure as slice 109, was allocated and a portion of the second term was stored therein. Concurrent with these operations, as also shown, a portion of a third term has been stored in a third slice, slice 107, also of 5 bytes. However, because the third term is larger than a Lucene level zero slice size of 5 bytes, a Lucene level one slice of 14 bytes, shown in the figure as slice 111, was allocated and a portion of the third term was stored therein. Further, because the third term is larger than the combination of a Lucene level zero slice plus a Lucene level one slice, which together total 15 bytes (5−4+14), a Lucene level two slice of 20 bytes, shown in the figure as slice 113, was allocated and a portion of the third term was stored therein. As explained above, such allocation of additional slices and storage of portions of terms therein also involved copying the last four bytes of a filled slice to a newly-allocated slice (e.g., the last four bytes of slice 105 were copied to slice 109, the last four bytes of slice 107 were copied to slice 111, and the last four bytes of slice 111 were copied to slice 113) as well as the writing of the RAM buffer address of the newly-allocated slice into the last four bytes of the filled slice as indicated by the arrows from slice 105 to slice 109, from slice 107 to slice 111, and from slice 111 to slice 113. This process is then repeated for additional terms in the postings list. As explained, once pool 100 is full, that is, all 32 kB block have been used to store postings, Lucene then allocates a new single pool of a greater number of blocks (not shown), and copies the data from pool 100 to the new, larger pool.

However, Lucene's indexing and storage process makes it difficult to perform search operations on Lucene's pool in the RAM buffer. Terms cannot directly be searched because of the delta encoding and variable integer compression process and even locating individual terms oftentimes requires multiple memory operations to traverse the non-contiguous slices containing them. Instead such search operations must wait until after the Lucene pool postings list has been flushed from the RAM buffer to long term storage, because the flushing operation decompresses and decodes the terms and stores them in a contiguous fashion.

What is needed is an improved way to index and store postings lists in the RAM buffer that avoids such limitations and constraints.

### SUMMARY OF THE INVENTION

One embodiment discloses a method for storing an index in working memory of a computing system that can concurrently be searched, the method comprising: allocating, by the computing system, a set of storage blocks in the working memory of the computing system, the allocated storage blocks defined as being in a hierarchy with each storage block subdivided into storage slices of an increasing size at each higher level in the defined storage block hierarchy; receiving, by the computing system, a request to store in the index a postings list comprising a set of integer index values; requesting, by the computing system, a storage slice at a lowest level in the defined storage block hierarchy not already containing any integer index values; storing, by the computing system, the set of integer index values in the requested storage slice at the lowest level in the defined storage block hierarchy; storing, by the computing system, under an index value equal to a term identifier for the postings list, an offset value of the requested storage slice; and, if there are additional integer index values, from the set of integer index values, that did not fit in the requested storage slice at the lowest level in the defined storage block hierarchy, then: requesting, by the computing system, a storage slice at a next higher level in the defined storage block hierarchy not already containing any integer index values; storing, by the computer system, in the requested storage slice at the lowest level in the defined storage block hierarchy, a pointer from the requested storage slice at the lowest level in the defined storage block hierarchy to the requested storage slice at the next higher level in the defined storage block hierarchy; and, storing, by the computing system, the additional integer index values in the requested slice at the next higher level in the defined storage block hierarchy.

Another embodiment discloses the method wherein: if the request, by the computing system, for the storage slice at the lowest level in the defined storage block hierarchy not already containing any integer index values failed because there were no more storage slices at the lowest level in the defined storage block hierarchy not already containing any integer values, then further comprising: allocating, by the computing system, an additional storage block in the working memory of the computing system, the allocated additional storage block defined as being at the lowest level in the defined storage block hierarchy; requesting, by the computing system, a storage slice in the allocated additional storage block defined as being at a lowest level in the defined storage block hierarchy; and wherein storing the set of integer index values in the requested storage slice at the lowest level in the defined storage block hierarchy instead stores the set of integer index values in the requested storage slice in the allocated additional storage block defined as being at the lowest level in the defined storage block hierarchy.

Yet another embodiment discloses the method further comprising: reading, by the computing system, at the index value equal to the term identifier, the stored offset value of the requested storage slice; and reading, by the computing system, at the read offset value, the set of integer index values in the requested storage slice.

Yet still another embodiment discloses the method further comprising: receiving, by the computing system, a request to store in the index another postings list comprising another set of integer index values; requesting, by the computing system, another storage slice at the lowest level in the defined storage block hierarchy not already containing any integer index values; and, storing, by the computing system, the another set of integer index values in the requested another storage slice at the lowest level in the defined storage block hierarchy essentially concurrently with the operation of reading the set of integer index values in the requested storage slice is occurring.

### BRIEF DESCRIPTION OF THE DRAWINGS

FIG. 1 is an example prior art index stored in working memory.

FIG. 2 is an index storage encoding schema according to an embodiment.

FIG. 3 is a working memory address encoding schema according to an embodiment.

FIG. 4 is an example live indexing set of pools in a RAM buffer according to an embodiment.

FIG. 5 is another example live indexing set of pools in a RAM buffer according to an embodiment.

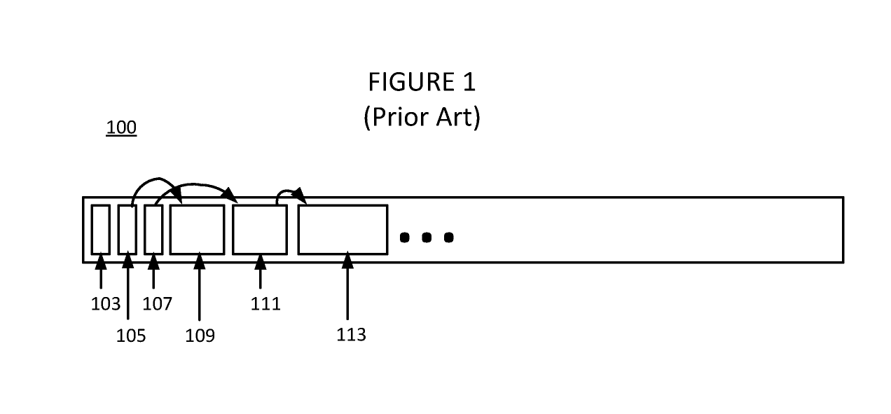

### DETAILED DESCRIPTION OF THE INVENTION

A method and apparatus is disclosed for creating and storing an inverted index as straight integer values into multiple levels of expandable pools that can be searched while being created and stored in a RAM buffer. This approach, referred to herein as “live indexing” due to the simultaneous searching capability, supports faster search operations by avoiding having to wait until after the RAM buffer has been flushed to long term memory.

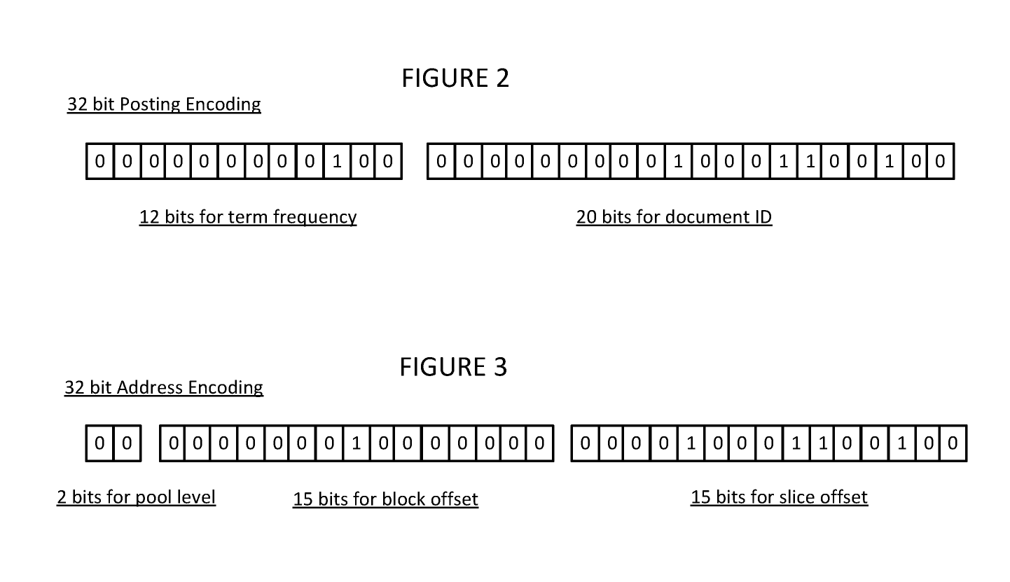

In an embodiment of live indexing, as shown in FIG. 2, each posting is encoded as a standard or straight 32 bit integer with 20 bits used to store the document identifier and 12 bits used to store the term frequency. With these values, the largest unflushed (i.e., stored in RAM buffer working memory rather than in long term storage) index can accommodate up to 2²⁰ documents and the maximum term frequency is 2¹².

In an embodiment, as shown in FIG. 3 and as will be explained, live indexing uses a 32 bit global address where 2 bits address a pool level, 15 bits specify a block offset to address a particular slice within a pool level, and the remaining 15 bits address an offset within a particular slice. This 32 bit address is used to address storage locations containing index values as well as for pointers within the live index.

In an embodiment, as explained further elsewhere herein, for each posting list, a pool starting offset (which is the offset into the pool, as will be explained) is stored in an offset table (or other data structure) under an index value equal to a term identifier to which the given posting list belongs. As such, the offset in the pool of a given term is obtained by performing a lookup in the offset table using the term identifier. Further, because the term identifier (which is given at the time the posting list is updated) is also an index into the offset table, the time to perform such table lookup remains constant.

In an embodiment, live indexing maintains four separate memory pools for holding postings, as will now be explained. Conceptually, each pool can be viewed as an unbounded integer array. In practice, pools are large integer arrays of 128 kiloByte blocks allocated as 2¹⁵ positions of 4 bytes each, and if a pool fills up then another block is allocated thereby growing that pool. In each pool, slices are allocated and used to hold individual postings belonging to a term. In each pool, the slice sizes are fixed, as follows: slice size for pool level zero is 2³×4 bytes (i.e., 32 bytes, capable of holding 8 four-byte straight integer values), slice size for pool level one is 2⁵×4 bytes (i.e., 128 bytes, capable of holding 32 four-byte straight integer values), slice size for pool level two is 2⁷×4 bytes (i.e., 512 bytes, capable of holding 128 four-byte straight integer values), and slice size for pool level three is 2¹¹×4 bytes (i.e., 8192 bytes, capable of holding 2048 four-byte straight integer values).

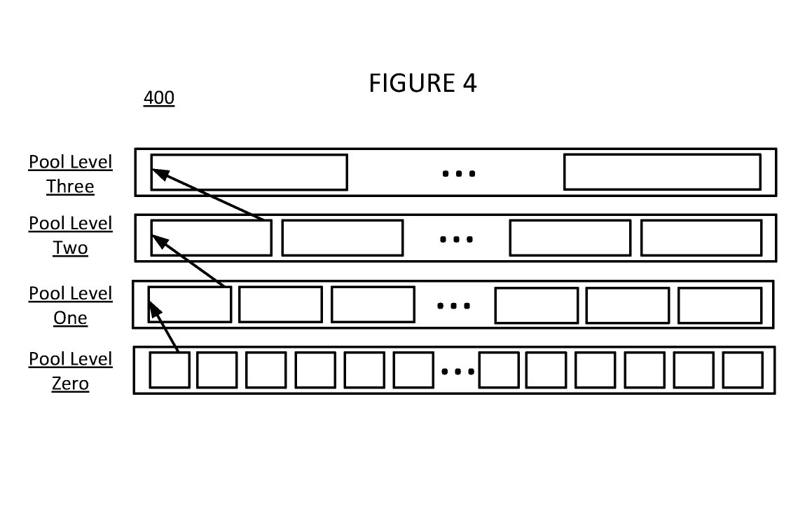

Referring now to FIG. 4, an example live indexing set of pools in a RAM buffer can be seen. Starting from all pools being empty, a single posting list containing 2000 document IDs, together with term frequencies, is to be stored as will now be described.

A request is made for a Pool Level Zero slice, which as has been explained can contain 2³ (8) integers. The first seven (2³−1) document IDs, along with corresponding term frequencies, are stored in the Pool Level Zero slice and the offset of the Pool Level Zero slice is stored in an offset table under an index equal to a term identifier for the postings list. Because there is more than one additional item in the posting list left to be stored (in this example, there are 2000−7=1993 additional items), another slice is needed. So, a request for a slice from Pool Level One is made, and a pointer from the Pool Level Zero slice to the Pool Level One slice is stored in the last position of the Pool Level Zero slice.

As has been explained, the Pool Level One slice can contain 2⁵ (32) integers. The next 31 (2⁵−1) document IDs, along with corresponding term frequencies, are stored in the Pool Level One slice. Because there is more than one additional item in the posting list left to be stored (in this example, there are 2000−7−31=1962 additional items), another slice is needed. So, a request for a slice from Pool Level Two is made, and a pointer from the Pool Level One slice to the Pool Level Two slice is stored in the last position of the Pool Level One slice.

As has been explained, the Pool Level Two slice can contain 2⁷ (128) integers. The next 127 document IDs, along with corresponding term frequencies, are stored in the Pool Level Two slice. Because there is more than one additional item in the posting list left to be stored (in this example, there are 2000−7−31−127=1835 additional items), another slice is needed. So, a request for a slice from Pool Level Three is made, and a pointer from the Pool Level Two slice to the Pool Level Three slice is stored in the last position of the Pool Level Two slice.

As has been explained, the Pool Level Three slice can contain 2¹¹ (2048) integers. The remaining 1835 document IDs, along with corresponding term frequencies, are stored in the Pool Level Three slice. Because this Pool Level Three slice is larger enough to contain all of the remaining document IDS, along with term frequencies, no additional slices are needed to store this posting list. However, if one or more additional slices were needed in order to store more document IDs, along with term frequencies, one or more requests would then be made for additional Pool Level Three slices to contain them.

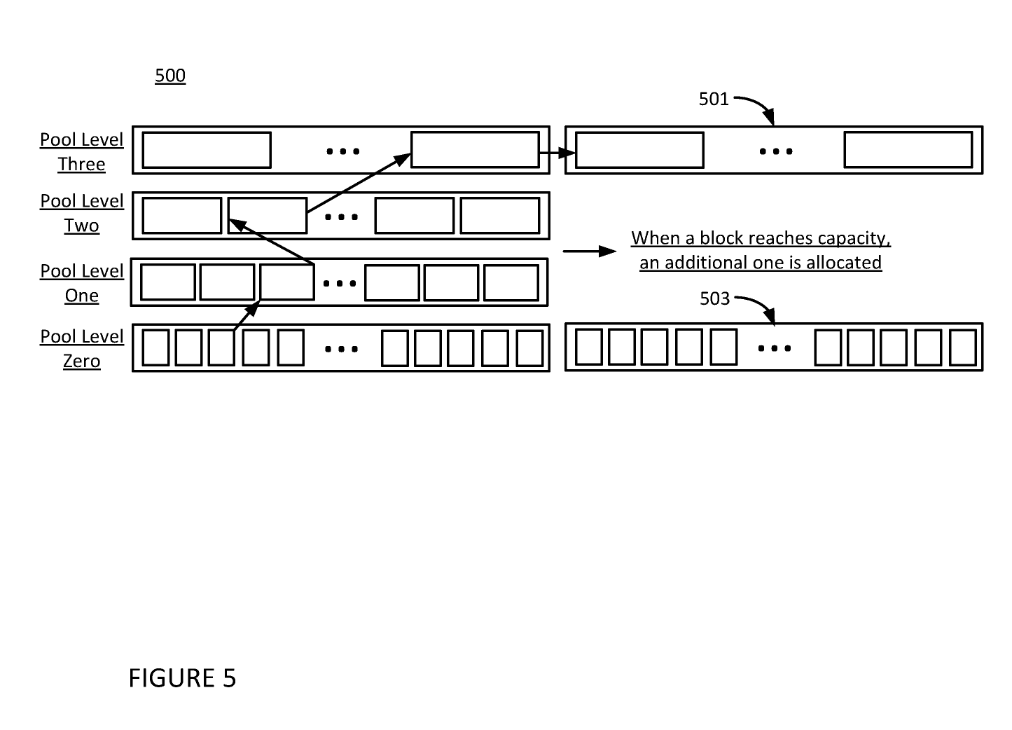

Referring now to FIG. 5, another example of a live indexing set of pools in a RAM buffer in accordance with an embodiment can be seen. As shown in this example, when a block at a given pool level reaches capacity (i.e., there are no remaining slices left to store content in that block of that pool level), then an additional block is allocated for that pool level. As shown in this example, this has occurred as is evident by the additional block 501 at Pool Level Three and the additional block 503 at Pool Level Zero.

As can also seen by reference to the example shown in FIG. 5, is the process of searching through the live index stored in the RAM buffer. The offset table is searched using the given term identifier to find the offset into the Pool Level Zero. The document IDs in the Pool Level Zero slice located at that offset is then read and, additional document IDs will be read from the higher pool levels (e.g., Pool Level One, Pool Level Two and Pool Level Three) using pointers stored in slices from lower pool levels, as indicated by the arrows in the figures. As one of skill in the art would understand from the teachings herein, the present live indexing approach has multiple levels of storage block pools, each level made up of one or more block subdivided into slices, where the slices are larger in size at higher pool levels, and where additional pool blocks are allocated at a given level when there are no more slices available at that level. Further, the postings list is encoded as straight integer values, rather than using delta encoding or variable integer compression. The stored values are therefore directly searchable and readable without first having to be flushed from working memory. This live indexing approach thus supports concurrent reads from (i.e., searches of) and writes to (i.e., storage to) the inverted index stored in the RAM buffer because, as has now been explained, the live indexing approach stores content in an immutable form in the RAM buffer, and there is therefore no risk of stale/inconsistent reads, unlike the prior approach of Lucene discussed above. Of course, one of skill in the art will understand that, in light of the teachings herein, although the operations are characterized as being performed concurrently, they do not necessarily occur at exactly the same point in time, but rather, can overlap or occur immediately before or after each other, in any sequence, thus appearing to occur essentially simultaneously and, again, without first having to wait until after a flushing operation from working memory to long term storage.

The disclosed system and method has been explained above with reference to several embodiments. Other embodiments will be apparent to those skilled in the art in light of this disclosure. Certain aspects of the described method and apparatus may readily be implemented using configurations or steps other than those described in the embodiments above, or in conjunction with elements other than or in addition to those described above. It will also be apparent that in some instances the order of steps described herein may be altered without changing the result of performance of all of the described steps.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

These and other variations upon the embodiments described and shown herein are intended to be covered by the present disclosure, which is limited only by the appended claims.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for storing an index in working memory of a computing system that can concurrently be searched, the method comprising:
allocating, by the computing system, a set of storage blocks in the working memory of the computing system, the allocated storage blocks defined as being in a hierarchy with each storage block subdivided into storage slices of an increasing size at each higher level in the defined storage block hierarchy;
receiving, by the computing system, a request to store in the index a postings list comprising a set of integer index values;
requesting, by the computing system, a storage slice at a lowest level in the defined storage block hierarchy not already containing any integer index values;
storing, by the computing system, the set of integer index values in the requested storage slice at the lowest level in the defined storage block hierarchy;
storing, by the computing system, under an index value equal to a term identifier for the postings list, an offset value of the requested storage slice; and,
if there are additional integer index values, from the set of integer index values, that did not fit in the requested storage slice at the lowest level in the defined storage block hierarchy, then:
requesting, by the computing system, a storage slice at a next higher level in the defined storage block hierarchy not already containing any integer index values;
storing, by the computer system, in the requested storage slice at the lowest level in the defined storage block hierarchy, a pointer from the requested storage slice at the lowest level in the defined storage block hierarchy to the requested storage slice at the next higher level in the defined storage block hierarchy; and,
storing, by the computing system, the additional integer index values in the requested slice at the next higher level in the defined storage block hierarchy.

2. The method of claim 1 wherein:
if the request, by the computing system, for the storage slice at the lowest level in the defined storage block hierarchy not already containing any integer index values failed because there were no more storage slices at the lowest level in the defined storage block hierarchy not already containing any integer values, then further comprising:
allocating, by the computing system, an additional storage block in the working memory of the computing system, the allocated additional storage block defined as being at the lowest level in the defined storage block hierarchy;
requesting, by the computing system, a storage slice in the allocated additional storage block defined as being at a lowest level in the defined storage block hierarchy;
and wherein storing the set of integer index values in the requested storage slice at the lowest level in the defined storage block hierarchy instead stores the set of integer index values in the requested storage slice in the allocated additional storage block defined as being at the lowest level in the defined storage block hierarchy.

3. The method of claim 1, further comprising:
reading, by the computing system, at the index value equal to the term identifier, the stored offset value of the requested storage slice; and,
reading, by the computing system, at the read offset value, the set of integer index values in the requested storage slice.

4. The method of claim 3 further comprising:
receiving, by the computing system, a request to store in the index another postings list comprising another set of integer index values;
requesting, by the computing system, another storage slice at the lowest level in the defined storage block hierarchy not already containing any integer index values; and,
storing, by the computing system, the another set of integer index values in the requested another storage slice at the lowest level in the defined storage block hierarchy essentially concurrently with the operation of reading the set of integer index values in the requested storage slice is occurring.

5. A non-transitory computer-readable storage medium having embodied thereon a program, the program being executable by a processor to perform a method for storing an index in working memory of a computing system that can concurrently be searched, the method comprising the steps of:
allocating a set of storage blocks in the working memory of the computing system, the allocated storage blocks defined as being in a hierarchy with each storage block subdivided into storage slices of an increasing size at each higher level in the defined storage block hierarchy;
receiving a request to store in the index a postings list comprising a set of integer index values;
requesting a storage slice at a lowest level in the defined storage block hierarchy not already containing any integer index values;
storing the set of integer index values in the requested storage slice at the lowest level in the defined storage block hierarchy;
storing under an index value equal to a term identifier for the postings list, an offset value of the requested storage slice; and,
if there are additional integer index values, from the set of integer index values, that did not fit in the requested storage slice at the lowest level in the defined storage block hierarchy, then:
requesting a storage slice at a next higher level in the defined storage block hierarchy not already containing any integer index values;
storing in the requested storage slice at the lowest level in the defined storage block hierarchy, a pointer from the requested storage slice at the lowest level in the defined storage block hierarchy to the requested storage slice at the next higher level in the defined storage block hierarchy; and,
storing the additional integer index values in the requested slice at the next higher level in the defined storage block hierarchy.

6. The non-transitory computer readable medium of claim 5, wherein:
if the request for the storage slice at the lowest level in the defined storage block hierarchy not already containing any integer index values failed because there were no more storage slices at the lowest level in the defined storage block hierarchy not already containing any integer values, then further comprising:
allocating an additional storage block in the working memory of the computing system, the allocated additional storage block defined as being at the lowest level in the defined storage block hierarchy;
requesting a storage slice in the allocated additional storage block defined as being at a lowest level in the defined storage block hierarchy:
and wherein storing the set of integer index values in the requested storage slice at the lowest level in the defined storage block hierarchy instead stores the set of integer index values in the requested storage slice in the allocated additional storage block defined as being at the lowest level in the defined storage block hierarchy.

7. The non-transitory computer readable medium of claim 5, wherein the method further comprises the steps:
reading at the index value equal to the term identifier, the stored offset value of the requested storage slice; and,
reading at the read offset value, the set of integer index values in the requested storage slice.

8. The non-transitory computer readable medium of claim 7, wherein the method further comprises the steps:
receiving a request to store in the index another postings list comprising another set of integer index values;
requesting another storage slice at the lowest level in the defined storage block hierarchy not already containing any integer index values; and,
storing the another set of integer index values in the requested another storage slice at the lowest level in the defined storage block hierarchy essentially concurrently with the operation of reading the set of integer index values in the requested storage slice is occurring.
